(19) United States
(12) Patent Application Publication
(10) Pub. No.: US 2018/0346643 A1
(43) Pub. Date: Dec. 6, 2018

(54) PROCESS FOR CONTROLLING THE STRUCTURE OF A BLOCK COPOLYMER BY SELECTIVE COPOLYMERIZATION, BY RING OPENING, OF CYCLIC CARBONATE AND LACTONE MONOMERS

(71) Applicants: ARKEMA FRANCE, COLOMBES (FR); CENTRE NATIONAL DE LA RECHERCHE SCIENTIFIQUE, PARIS (FR); UNIVERSITE PAUL SABATIER (TOULOUSE III), TOULOUSE (FR)

(72) Inventors: Christophe NAVARRO, BAYONNE (FR); Didier BOURISSOU, PLAISANCE DU TOUCH (FR); Blanca MARTIN-VACA, TOULOUSE (FR); Aline COUFFIN, BALSAC (FR); Franck KAYSER, TOULOUSE (FR)

(73) Assignees: ARKEMA FRANCE, COLOMBES (FR); CENTRE NATIONAL DE LA RECHERCHE SCIENTIFIQUE, PARIS (FR); UNIVERSITE PAUL SABATIER (TOULOUSE III), TOULOUSE (FR)

(21) Appl. No.: 15/780,897

(22) PCT Filed: Nov. 29, 2016
(86) PCT No.: PCT/FR2016/053135

§ 371 Date: Jun. 1, 2018

(30) Foreign Application Priority Data
Dec. 4, 2015 (FR) 15.61864

(51) Int. Cl. C08G 63/82; C08G 64/18; C08G 64/30; C08G 81/02; C08K 5/42; C08K 5/053

(52) U.S. Cl. CPC C08G 63/823; C08G 64/18; C08K 5/053; C08G 81/027; C08K 5/42; C08G 64/302

(57) ABSTRACT

The invention relates to a process for controlling the structure of a block copolymer by selective copolymerization, by ring opening, of cyclic carbonate and lactone monomers in the presence of a catalyst based on methanesulfonic acid, the said process comprising a sequence of stages carried out strictly in the following order:
a) dissolving the cyclic carbonate monomer in a nonchlorinated aromatic solvent,
b) adding, to the monomer solution, a bifunctional initiator chosen from diols or water,
c) adding methanesulfonic acid (MSA) as catalyst of the polymerization reaction,
d) when all the cyclic carbonate has been consumed, a telechelic polycarbonate capable of acting as macroinitiator of polymerization of the lactone is obtained,
e) adding the lactone to the reaction medium in order to selectively obtain a block copolymer.

### TECHNICAL FIELD

The invention relates to the field of the selective copolymerization of cyclic monomers.

More particularly, the invention relates to a process for controlling the structure of a block copolymer synthesized by selective copolymerization, by ring opening, of cyclic carbonate and lactone monomers.

### PRIOR ART

The ring opening polymerization of cyclic carbonates and lactones has been studied for some years as the polymers which result therefrom exhibit a certain industrial advantage in various fields as a result of their biodegradability and biocompatibility. Thus, polycarbonates in the form of homopolymers or of copolymers with other biodegradable polyesters can be used as an encapsulant for medicaments or as biodegradable implants, in particular in orthopaedics, in order to put an end to the operations which are necessary in the past to remove the metal parts, such as pins, for example. Such polymers can also be used in coating and plastic formulations. For their part, polycaprolactones are also biocompatible and biodegradable. They exhibit good physical chemical properties and a good thermal stability up to temperatures of at least 200-250° C.

Organocatalysts have been developed in order to make possible the ring opening polymerization of lactones, in particular ε-caprolactone, denoted “ε-CL” in the continuation of the description, and of cyclic carbonates, in particular trimethylene carbonate, denoted “TMC” in the continuation of the description. Patent applications WO2008104723 and WO200810472 and also the paper entitled “Organo-catalyzed ROP of ε-caprolactone: methanesulfonic acid competes with trifluoromethanesulfonic acid”, Macromolecules, 2008, Vol. 41, pp. 3782-3784, have demonstrated in particular the effectiveness of methanesulfonic acid, denoted “MSA” in the continuation of the description, as catalyst of the polymerization of ε-caprolactone.

Likewise, Patent Application WO2010112770 and the paper entitled “Ring-opening polymerization of trimethylene carbonate catalysed by methanesulfonic acid: activated monomer versus active chain end mechanisms”, Macromolecules, 2010, Vol. 43, pp. 8828-8835, have demonstrated the effectiveness of methanesulfonic acid (MSA) as catalyst of the polymerization of trimethylene carbonate (TMC). Furthermore, in the case of the polymerization of TMC, competition between two propagation mechanisms has been demonstrated: propagation by activated monomer, denoted “AM” in the continuation of the description, and propagation by active chain end, denoted “ACE” in the continuation of the description. These two competing propagation mechanisms are illustrated in Scheme 1 below.

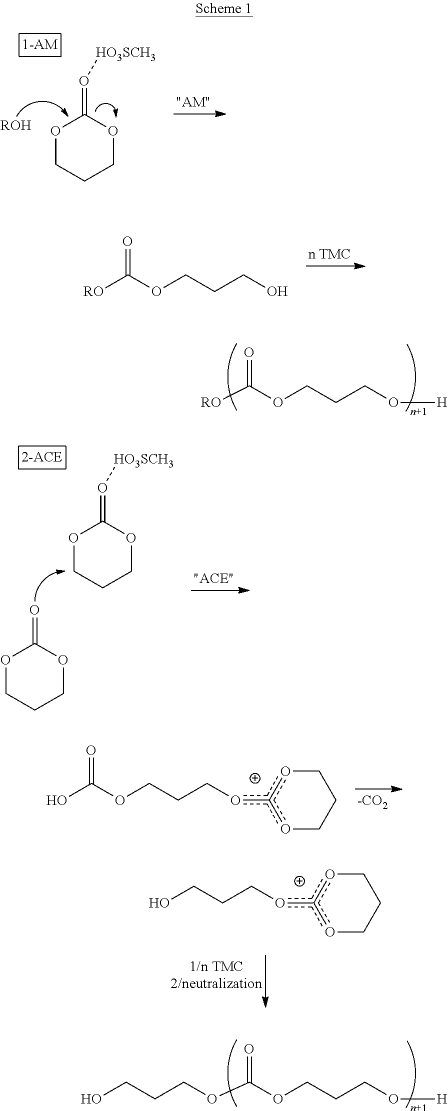

The documents mentioned above also describe that, in combination with the protic initiator of alcohol type, MSA is capable of promoting the control polymerization of the cyclic ε-caprolactone and trimethylene carbonate monomers. In particular, the protic initiator makes possible fine control of the average molar masses and also of the chain ends.

Following the studies on the ring opening polymerization of lactones and cyclic carbonates, the synthesis of copolymers combining these two types of monomers has been broached.

Thus, the document entitled “Copolymerization of ε-caprolactone and trimethylene carbonate catalysed by methanesulfonic acid”, Eur. Polym. J., 2013, Vol. 49, pp. 4025-4034, describes the simultaneous copolymerization of ε-caprolactone and trimethylene carbonate TMC, catalysed by methanesulfonic acid MSA. This simultaneous copolymerization results in the formation of random copolymers. This study made it possible to observe the formation of two different populations of random copolymers. A first population corresponds to that expected, with chains having an ester ending on one side, corresponding to the initiation with an alcohol, and a hydroxyl ending on the other. The second population comprises random copolymers consisting of chains having two hydroxyl endings, also known as telechelic copolymers. This second population of copolymers derives from the competing mechanism of propagation, of “ACE” type, of the TMC. In order to promote the exclusive formation of telechelic polymer chains, exhibiting two hydroxyl endings, the document describes the use of a diol as initiator and more particularly 1,4-phenylenedimethanol. The two competing mechanisms of propagation then give rise to the formation of random copolymers of telechelic type, differing only in the central unit. In a first case, the central unit is a phenylene and the polymer chain obtained derives from the mechanism of propagation of “AM” type and, in the second case, the central unit is a propylene and the polymer chain obtained derives from the combination of the mechanisms of propagation of “AM” and “ACE” type.

Furthermore, it is known that telechelic polymers can act as macroinitiator in the synthesis of block copolymers. Thus, the document entitled “Recent advances in ring-opening polymerization strategies toward α,ω-hydroxyl telechelic and resulting copolymers”, Eur. Polym. J., 2013, Vol. 49, pp. 768-779, describes the possibility of producing a nonisocyanate polyurethane from a telechelic PTMC or a block copolymer of PMMA-b-PLC-b-PMMA type from a telechelic polycaprolactone (PLC), for example.

Starting from the existing studies on the ring opening polymerization of ε-caprolactone, ε-CL, and trimethylene carbonate, TMC, the applicant Company has attempted to synthesize block copolymers based on these two types of monomers. Many applications are envisaged for block copolymers of this type. They can be linked to the fields of surgery and orthopaedics, for example, as a result of the biocompatibility of these copolymers. The block copolymers can also act as additives in polymeric matrices for improving the impact strength of a final material. Finally, the block copolymers have an ability to develop a nanostructure, that is to say that the arrangement of the constituent blocks of the copolymers develops a structure, by phase separation between the blocks, thus forming nanodomains. As a result of this phase segregation, they can act as masks in nanolithography processes for producing products of the microelectronics field and micro-electro-mechanical systems (MEMS).

The document entitled “Mild and efficient preparation of block and gradient copolymers by methanesulfonic acid catalysed ring-opening polymerization of caprolactone and trimethylene carbonate”, Macromolecules, 2013, Vol. 46, pp. 4354-4360, describes different syntheses of block or gradient copolymers based on these two monomers, ε-CL and TMC. During the preparation of such a copolymer, the simultaneous introduction of ε-CL and TMC results in the synthesis of a random or gradient copolymer but not in a block copolymer. In order to be able to synthesize a block copolymer, the introduction of each monomer one after the other has thus been envisaged. However, the Applicant Company has found that such a synthesis presents a problem as the different mechanisms of propagation of the TMC (ACE and AM) come into competition and result in a mixture of block copolymers with other block or nonblock copolymers and/or other homopolymers being obtained. Consequently, it is very difficult to control the structure of the block copolymers obtained, which can affect the applications to which these copolymers are intended.

In point of fact, it is difficult to obtain these mixtures of populations of polymers for the structure of the block copolymers. This is because the contamination of a block copolymer by another or several other polymers, whether block or gradient or even homopolymers, can disrupt the phase segregation between the blocks of the targeted copolymer and thus the structuring which it is desired to obtain in nanodomains at the micro- or nanometric scale.

### Technical Problem

It is thus an aim of the invention to overcome at least one of the disadvantages of the prior art. In particular, it is an aim of the invention to provide a process for controlling the structure of a block copolymer by selective copolymerization, by ring opening, of the cyclic carbonate and lactone monomers in the presence of a catalyst based on methanesulfonic acid, the said process making it possible to obtain just one population of block copolymer, free from contamination by other copolymers or homopolymers, and with a perfectly defined and controlled structure.

### BRIEF DESCRIPTION OF THE INVENTION

In point of fact, the Applicant Company has discovered that this problem can be solved by scrupulously observing a sequence of stages in a strictly defined order.

To this end, the invention relates to a process for controlling the structure of a block copolymer by selective copolymerization, by ring opening, of cyclic carbonate and lactone monomers in the presence of a catalyst based on methanesulfonic acid, the said process comprising a sequence of stages carried out strictly in the following order:
a) dissolving the cyclic carbonate monomer in a nonchlorinated aromatic solvent,
b) adding, to the monomer solution, a bifunctional initiator chosen from diols or water,
c) adding methanesulfonic acid as catalyst of the polymerization reaction,
d) when all the cyclic carbonate has been consumed, a telechelic polycarbonate capable of acting as macroinitiator of polymerization of the lactone is obtained,
e) adding the lactone to the reaction medium in order to selectively obtain a block copolymer.

This sequence of stages in this precise order, and strictly in this order, makes it possible to obtain just one population of block copolymer, in particular triblock copolymer, the central block of which is a polycarbonate, free of any contamination by other polymers, so that the structure of the block copolymer can be controlled.

According to other optional characteristics of the process:
the cyclic carbonate is trimethylene carbonate (TMC), the lactone is ε-caprolactone (ε-CL) and the copolymer obtained is a P(CL-b-TMC-b-CL) triblock copolymer;
the molar ratio of monomers to initiator, TMC/ε-CL/initiator, is between 60/60/1 and 120/240/1;
the initiator/catalyst (MSA) molar ratio is between 1/1 and 1/3;
the process is carried out at a temperature of between 20 and 120° C. and preferably of between 30 and 60° C.;
the nonchlorinated aromatic solvent is chosen from toluene, ethylbenzene or xylene.

The invention relates in addition to a PCL-b-PTMC-b-PCL block copolymer obtained in accordance with a control process described above, the said block copolymer being characterized in that each of the PCL blocks exhibits a degree of polymerization of between 30 and 120 and a number-average molecular weight Mn of between 3400 and 13680 g/mol and that the PTMC block exhibits a degree of polymerization of between 60 and 120 and a number-average molecular weight Mn of between 6100 and 12200 g/mol.

Other advantages and characteristics of the invention will become apparent on reading the following description, given by way of illustrative example and without limitation.

### DESCRIPTION OF THE INVENTION

As preamble, it is specified that the expression “of between” used in the context of this description should be understood as including the limits cited.

The term “monomer” as used refers to a molecule which can undergo a polymerization.

The term “polymerization” as used refers to the process for the conversion of a monomer or of a mixture of monomers into a polymer, the structure of which essentially comprises the multiple repetition of units derived from monomer molecules of lower molecular weight.

“Polymer” is understood to mean either a copolymer or a homopolymer.

“Copolymer” is understood in particular to mean a polymer derived from at least two types of monomers or macromonomers, one at least of which is chosen from a lactone and the other from a cyclic carbonate.

“Homopolymer” is understood to mean a polymer derived from just one type only of monomer or macromonomer.

“Block copolymer” is understood to mean a polymer comprising one or more uninterrupted sequences of each of the separate polymer types, the polymer sequences being chemically different from each other or from one another and being bonded together by a covalent bond.

The process for controlling the structure of a block copolymer according to the invention is carried out by selective copolymerization, by reopening, of cyclic carbonate and lactone monomers in the presence of a catalyst based on methanesulfonic acid.

Preferably, the cyclic carbonate monomer is trimethylene carbonate (TMC) and the lactone is ε-caprolactone (ε-CL). The block copolymer synthesized according to this control process is advantageously a PCL-b-PTMC-b-PCL triblock copolymer, the central block of which is PTMC, formed during a first phase of the selective copolymerization.

This selective copolymerization advantageously comprises a sequence of stages carried out strictly in a predetermined order. A first step consists in dissolving the cyclic carbonate monomer, in particular the TMC, in a nonchlorinated aromatic solvent.

The nonchlorinated aromatic solvent can be chosen from toluene, ethylbenzene or xylene. However, toluene is preferred to the other two solvents.

A second stage subsequently consists in adding, to the solution of TMC monomer, a bifunctional initiator comprising at least two hydroxyl functional groups. This initiator can in particular be chosen from diols or water. Methanesulfonic acid (MSA), which acts as catalyst of the reaction for the polymerization of TMC, is then added to the reaction medium.

By virtue of the use of water or of a diol as initiator of the polymerization of the TMC, in the presence of MSA in order to catalyse the reaction, a telechelic PTMC polymer, that is to say a PTMC polymer carrying a hydroxyl function group at each of its ends, is formed. This is because, as illustrated in Scheme 2 below, the opening of the TMC by nucleophilic addition of a water molecule forms a carbonic acid which spontaneously releases carbon dioxide CO₂ to produce propane-1,3 diol. The propane-1,3 diol thus formed then acts as bifunctional initiator of the polymerization of the TMC according to the activated monomer “AM” propagation mechanism. The PTMC polymer thus formed is a telechelic polymer, the structure of which is entirely identical to that of the PTMC polymer formed according to the competing mechanism, by active chain end “ACE”. Consequently, just one population of dihydroxylated PTMC polymer is obtained at this stage.

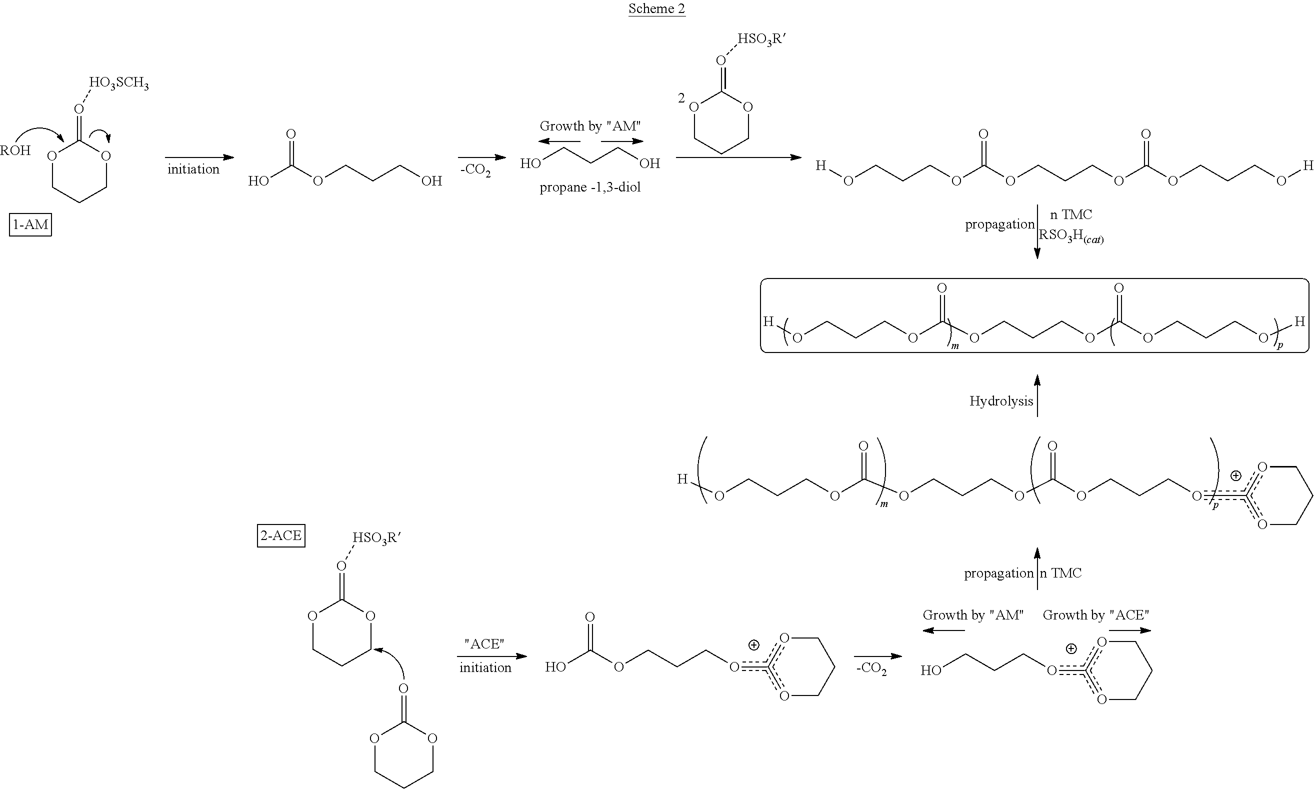

When all the cyclic carbonate monomer is consumed, that is to say when all the TMC is consumed, just one telechelic polycarbonate, in particular the dihydroxylated PTMC polymer, present in the reaction medium is obtained. This polymer can then act, in a second phase of the selective copolymerization process, as macroinitiator of polymerization of the lactone, in particular of ε-caprolactone, ε-CL.

In order to carry out this second polymerization, the lactone is thus added to the reaction medium. Just one population of PCL-b-PTMC-b-PCL triblock copolymers is then selectively obtained, according to the reaction Scheme 3 below.

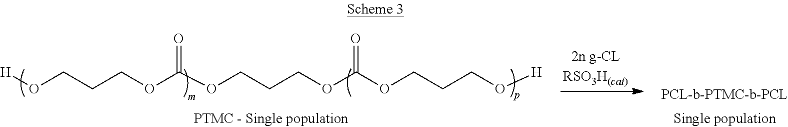

This strict sequence of the stages of synthesis of the block copolymer makes it possible to obtain a defined structure, free of contamination by homopolymers or by other types of block or random copolymers. When the order of addition is reversed (first the ε-CL and subsequently the TMC), the block copolymer obtained is contaminated by PTMC homopolymer. Control of the structure is very important as contamination by other types can disrupt the structuring by phase segregation.

A very important characteristic of the block copolymers is the phase segregation of the blocks, which separate to give nanodomains. This phase separation depends essentially on two parameters. A first parameter, designated Flory-Huggins interaction parameter and denoted “χ”, makes it possible to control a size of the nanodomains. More particularly, it defines the tendency of the blocks of the block copolymer to separate into nanodomains. The product χN, of the degree of polymerization N and of the Flory-Huggins parameter χ, gives an indication with regard to the compatibility of two blocks and if they can separate. For example, a diblock copolymer with a strictly symmetrical composition separates into microdomains if the product χN is greater than 10.49. If this product χN is less than 10.49, the blocks become mixed and the phase separation is not observed at the observation temperature.

Consequently, in order to be able to observe phase segregation between the blocks of the triblock copolymer synthesized according to the process of the invention, the degree of polymerization of the blocks has to be sufficiently high. The concentration of each monomer in the reaction medium can thus vary to a certain extent.

This is the reason why the monomers/initiator (TMC/ε-CL/initiator) molar ratio is preferably between 60/60/1 and 120/240/1. This is because a lower ratio, for example 40/40/1, does not make it possible to observe phase segregation.

Thus, for a degree of polymerization of the PCL varying between 60 and 240 (30 and 120 per block respectively), PCL blocks for which the number-average molecular weight Mn is between 3400 and 13680 g/mol are obtained. Likewise, for a degree of polymerization of the PTMC of between 60 and 120, PTMC blocks for which the number-average molecular weight Mn is between 6100 and 12200 g/mol are obtained.

It is possible to vary the amount of MSA catalyst employed in the process, in order to adjust the reaction time without affecting the control of the polymerization. Normally, it is preferable for the molar ratio of the dihydroxylated initiator to the MSA catalyst to be of the order of 1. However, it can vary between 1/1 and 1/3.

The catalyst can be easily removed at the end of the reaction by neutralization using a hindered organic base, such as diisopropylethylamine (DIEA), or a tertiary amine supported on a resin of polystyrene type.

The bifunctional initiator is chosen from diols or water. In general, the triblock copolymer synthesized with such an initiator exhibits a linear morphology. However, when the initiator is provided in the form of a polyhydroxylated polymer, such as, for example, glycerol, pentaerythritol, dipentaerythritol, trimethylolethane, trimethylolpropane, or sorbitol, it can make it possible to obtain triblock copolymers exhibiting a star-branched morphology.

This process is preferably carried out at a temperature ranging from 20 to 120° C. and more preferably between 30 and 60° C., in particular when the solvent is toluene. This is because it is possible to obtain, at a temperature of the order of 30° C., PCL-b-PTMC-b-PCL block copolymers having molecular weights Mn of greater than 18000 g/mol in a few hours and with a yield of greater than or equal to 80% after purification.

In addition, this process is preferably carried out with stirring. It can be carried out continuously or batchwise.

Finally, the reactants used in this process are preferably dried before they are used, in particular by treatment under vacuum, distillation or drying by an inert dehydrating agent.

### EXAMPLES

The following general procedure which is used to carry out the processes described below.

The alcohols were distilled over sodium. The toluene is dried using an MBraun SPS-800 solvent purification system. The trimethylene carbonate TMC was dried in a dry tetrahydrofuran (THF) solution over calcium dihydride (CaH₂) and recrystallized three times from cold THF. The methanesulfonic acid (MSA) was used without additional purification. The diisopropylethylamine (DIEA) was dried and distilled over CaH₂ and stored over potassium hydroxide (KOH).

The Schlenk tubes were dried with a heat gun under vacuum in order to remove any trace of moisture.

The reaction was monitored by ¹H NMR (proton nuclear magnetic resonance) on a Brucker Avance 300 and 500 device and by size exclusion chromatography (SEC) in THF. To do this, samples were withdrawn, neutralized with DIEA, evaporated and taken up in an appropriate solvent for the purpose of their characterization. ¹H NMR makes it possible to quantify the degrees of polymerization (DPs) of the TMC and ε-CL monomers by determining the integration ratio of half of the signals of the —CH₂— groups carrying the OC(═O)O functional group and the C═O functional group respectively to the signals of the CH₂ protons carrying the —OH functional group initially on the initiator. The spectra are recorded in deuterated chloroform on a 500 or 300 MHz spectrometer according to the examples. The number-average molecular weight Mn, the weight-average molecular weight Mw and the polydispersity index (PDI) of the samples of copolymers withdrawn are measured by size exclusion chromatography SEC in THF with polystyrene calibration.

The measurement by differential scanning calorimetry, denoted DSC, makes it possible to study the glass transitions and the crystallization. DSC is a thermal analysis technique which makes it possible to measure the differences in the exchanges of heat between a sample to be analyzed and a reference during phase transitions. A Netzsch DSC204 differential scanning calorimeter was used to carry out this study.

The calorimetry analyses were carried out between −80 and 130° C. and the T_{g} and Tₘ values were recorded during the second rise in temperature (at a rate of 10° C./min).

### Example 1 (Comparative): Preparation of a PCL-b-PTMC Diblock Copolymer (with Introduction of ε-CL First into the Reaction Medium)

The initiator, n-pentanol, (9 μl, 0.08 mmol, 1 equiv.) and methanesulfonic acid (0.2 mmol, 3 equiv.) are successively added to a solution of ε-caprolactone (700 μL, 6.6 mmol, 80 equiv.) in toluene (7.3 ml, [ε-CL]₀=0.9 mol/l). The reaction medium is stirred at 30° C. under argon for 2 h. Once the ε-CL monomer has been completely consumed, which is established by monitoring by ¹H NMR, the trimethylene carbonate TMC (675 mg, 6.6 mmol, 80 equiv.) is added to the reaction medium and the solution is stirred at 30° C. under argon for 7 h. An excess of diisopropylethylamine (DIEA) is subsequently added in order to neutralize the catalyst, and the solvent is evaporated under vacuum. The polymer obtained is then dissolved in the minimum amount of dichloromethane, precipitated by addition to cold methanol, filtered off and dried under vacuum.

The results obtained are as follows:

A PCL₈₀-b-PTMC₈₀ copolymer is obtained with a degree of conversion of greater than 96% and a yield of 90%.

¹H NMR (CDCl₃, 500 MHz): 4.24 (t, 4H×80, J=6.0 Hz, —OCH₂CH₂CH₂O—), 4.13 (t, 2H, J=6.5 Hz, —OCH₂, CL-TMC diad), 4.06 (t, 2H×80, J=7.0 Hz, —OCH₂(CH₂)₄C(O)—), 3.74 (t, >2H, J=6.0 Hz —CH₂OH, TMC end), 2.30 (t, 2H×80, J=7.5 Hz, —C(O)CH₂(CH₂)₄O), 2.05 (m, 2H×80, —OCH₂CH₂CH₂O), 1.64 (m, 4H×80, —OCH₂CH₂CH₂CH₂CH₂C(O)), 1.38 (m, 2H×80, —O(CH₂)₂CH₂(CH₂)₂C(O)), 0.90 (t, 3H, J=7.0 Hz, CH₃);
SEC (THF): Mn˜15 650 g/mol, PDI: Mw/Mn˜1.1.

The integration of the signal corresponding to the —CH₂OH ending of the PTMC block is markedly greater than 2, indicating the presence of polymer chains other than those initiated by the hydroxylated polycaprolactone PCL-OH. This thus means that the PCL-b-PTMC diblock copolymer synthesized is not alone but mixed with another PTMC homopolymer of telechelic type.

### Example 2 (Comparative): Preparation of a PTMC-b-PCL-b-PTMC Triblock Copolymer (with Introduction of ε-CL First)

The initiator, butane-1,4-diol (0.8 ml, 8.9 mmol, 1 equiv.) and methanesulfonic acid (0.27 mL, 4.5 mmol, 0.5 equiv.) are successively added to a solution of ε-caprolactone (23.2 mL, 0.219 mol, 25 equiv.) in toluene (230 mL, [ε-CL]₀=0.9 mol/L). The reaction medium is stirred at 30° C. under argon for 6 h 30. Once the ε-CL monomer has been completely consumed, we establish by monitoring by ¹H NMR, the trimethylene carbonate TMC (25 g, 0.245 mol, 27 equiv.) is added to the reaction medium and the solution is stirred under argon at 30° C. for 2.5 h. An excess of diisopropylethylamine (DIEA) is subsequently added to neutralize the catalyst, and the solvent is evaporated under vacuum. The polymer obtained is then dissolved in the minimum amount of dichloromethane, precipitated by addition to cold methanol, filtered off and dried under vacuum.

The results obtained are as follows:

A PTMC-b-PCL-b-PTMC copolymer is obtained with a degree of conversion of greater than 96% and a yield of 85%.

¹H NMR (CDCl₃, 300 MHz): 4.23 (t, 4H×24.5, J=6.3 Hz, n —OCH₂CH₂CH₂O—), 4.12 (t, 4H, J=6.7 Hz, —(CH₂)₅C(O)OCH₂CH₂CH₂), 4.05 (t, 2H×22.5, J=6.6 Hz, —OCH₂(CH₂)₄C(O)—), 3.73 (m, >4H, HOCH₂(CH₂)₂—), 2.30 (t, 2H×21.5, J=7.5 Hz, —COCH₂(CH₂)₄O—), 2.04 (m, 2H×24.8+4H, n —OCH₂CH₂CH₂O and —OCH₂CH₂CH₂OH), 1.90 (m, 4H, —OCH₂(CH₂)₂CH₂O—), 1.64 (m, 4H×22+4H, —OCH₂CH₂CH₂CH₂CH₂C(O) and HOCH₂CH₂CH₂CH₂CH₂C(O)), 1.38 (m, 2H×22+2H+2H, —O(CH₂)₂CH₂(CH₂)₂C(O) and HO(CH₂)₂CH₂(CH₂)₂C(O)).

The integration of the signal corresponding to the —CH₂OH ending of the PTMC block is greater than 4, indicating the presence of polymer chains other than those initiated by the dihydroxylated polycaprolactone HO-PCL-OH. This thus means that the PTMC-b-PCL-b-PTMC triblock copolymer synthesized is not alone but mixed with another PTMC homopolymer of telechelic type.
SEC (THF): Mn˜4900 g/mol, PDI: Mw/Mn˜1.19;
SEC (THF): Mn˜4900 g/mol, Mw/Mn˜1.19;
DSC: T_{g1}=−48.6° C., Tₘ=42.1° C.

### Example 3 (Invention): Preparation of a PCL-b-PTMC-b-PCL Triblock Copolymer with an ε-CL/TMC Ratio of 2/1

The initiator, water, (2 μl, 0.10 mmol, 1 equiv.) and methanesulfonic acid (22 μl, 0.30 mmol, 3 equiv.) are successively added to a solution of TMC (907 mg, 8.9 mmol, 80 equiv.) in toluene (9.0 ml, [TMC]o=0.98 mol/l). The reaction medium is stirred at 30° C. under argon for 6 h 30. Once the TMC monomer has been completely consumed, which is established by monitoring by ¹H NMR, the ε-CL (1.9 mL, 160 equiv.) is added and the solution is stirred at 30° C. under argon for 8 h. An excess of diisopropylethylamine (DIEA) is subsequently added in order to neutralize the catalyst, and the solvent is evaporated under vacuum. The polymer is then dissolved in the minimum amount of dichloromethane, precipitated by addition to cold methanol, filtered off and dried under vacuum.

The results obtained are as follows:

A PCL-b-PTMC-b-PCL copolymer is obtained with a degree of conversion of greater than 96% and a yield of 85%.

¹H NMR (CDCl₃, 300 MHz): 4.23 (t, 4H×52, J=6.3 Hz, n —OCH₂CH₂CH₂O—), 4.12 (t, 4H, J=6.7 Hz, —(CH₂)₅C(O)OCH₂CH₂CH₂), 4.05 (t, 2H×101, J=6.6 Hz, —OCH₂(CH₂)₄C(O)—), 3.64 (t, 4H, J=6.5 Hz, HOCH₂(CH₂)₄—), 2.30 (t, 2H×107, J=7.5 Hz, —COCH₂(CH₂)₄O—), 2.04 (m, 2H×53+4H, n —OCH₂CH₂CH₂O and —OCH₂CH₂CH₂OH), 1.64 (m, 4H×110+4H, —OCH₂CH₂CH₂CH₂CH₂C(O) and HOCH₂CH₂CH₂CH₂CH₂C(O)), 1.38 (m, 2H×108+2H+2H, —O(CH₂)₂CH₂(CH₂)₂C(O) and HO(CH₂)₂CH₂(CH₂)₂C(O)).

The absence of triplet signal at 3.74 ppm (corresponding to the CH₂OH group of an end TMC unit) indicates that all the polymer chains have CH₂OH ends of a caprolactone unit (t signal at 3.64 ppm). This confirms the absence of telechelic PTMC homopolymer.
SEC (THF): Mn˜29 370 g/mol, PDI: Mw/Mn˜1.18;
DSC: T_{g1}=−55° C., T_{g2}=−27° C., Tₘ=53° C.

The two glass transition temperatures Tg1 and Tg2 identified are similar to the glass transition temperatures of each PCL and PTMC homopolymer respectively, indicating the observation of a phase segregation between the blocks.

### Example 4 (Invention): Preparation of a PCL-b-PTMC-b-PCL Triblock Copolymer with an ε-CL/TMC Ratio of 1/1

The initiator, butane-1,4-diol (4 μl, 0.046 mmol, 1 equiv.) and methanesulfonic acid (18 μl, 0.3 mmol, 6 equiv. (3 per hydroxyl function group)) are successively added to a solution of TMC (381 mg, 3.73 mmol, 80 equiv.) in toluene (7.2 ml, [TMC]o=0.5 mol/l). The reaction medium is stirred at 40° C. under argon for 2 h 30. Once the TMC monomer has been completely consumed, which is established by monitoring ¹H NMR, the ε-CL (420 μl, 3.96 mmol, 80 equiv.) is added and the solution is stirred at 40° C. under argon for 1 h. An excessive diisopropylethylamine (DIEA) is subsequently added in order to neutralize the catalyst, and the solvent is evaporated under vacuum. The polymer is then dissolved in the minimum amount of dichloromethane, precipitated by addition to cold methanol, filtered off and dried under vacuum.

The results obtained are as follows:

A PCL-b-PTMC-b-PCL copolymer is obtained with a degree of conversion of greater than 96% and a yield of 83%.

¹H NMR (CDCl₃, 300 MHz): 4.23 (t, 4H×50, J=6.3 Hz, n —OCH₂CH₂CH₂O—), 4.12 (t, 4H, J=6.7 Hz, —(CH₂)₅C(O)OCH₂CH₂CH₂), 4.05 (t, 2H×46, J=6.6 Hz, —OCH₂(CH₂)₄C(O)—), 3.64 (t, 4H, J=6.5 Hz, HOCH₂(CH₂)₄—), 2.30 (t, 2H×46, J=7.5 Hz, —COCH₂(CH₂)₄O—), 2.04 (m, 2H×50+4H, n —OCH₂CH₂CH₂O and —OCH₂CH₂CH₂OH), 1.64 (m, 4H×46+4H, —OCH₂CH₂CH₂CH₂CH₂C(O) and HOCH₂CH₂CH₂CH₂CH₂C(O)), 1.38 (m, 2H×46+2H+2H, —O(CH₂)₂CH₂(CH₂)₂C(O) and HO(CH₂)₂CH₂(CH₂)₂C(O)).

The absence of triplet signal at 3.74 ppm (corresponding to the CH₂OH group of an end TMC unit) indicates that all the polymer chains have CH₂OH ends of a caprolactone unit (t signal at 3.64 ppm). This confirms the absence of telechelic PTMC homopolymer.
SEC (THF): Mn˜17 800 g/mol, PDI: Mw/Mn˜1.17;
DSC: T_{g1}: not observed; T_{g2}=−28.9° C., Tₘ=47.7° C.

The T_{g} value observed (−28.9° C.) is similar to the glass transition temperature of the PTMC homopolymer, indicating the observation of a phase segregation between the PTMC and PCL blocks. The size and the semicrystalline nature of the PCL block makes it difficult to observe the T_{g1} corresponding to this block.

### Example 5 (Invention): Preparation of a PCL-b-PTMC-b-PCL Triblock Copolymer with an ε-CL/TMC Ratio of 1/2

The initiator, butane-1,4-diol (4.6 μl, 0.055 mmol, 1 equiv.) and methanesulfonic acid (21 μl, 0.30 mmol, 3 equiv.) are successively added to a solution of TMC (450 mg, 4.4 mmol, 80 equiv.) in toluene (8.4 ml, [TMC]o=0.5 mol/l). The reaction medium is stirred at 40° C. under argon for 2 h 30. Once the TMC monomer has been completely consumed, which is established by monitoring by ¹H NMR, the ε-CL (245 μl, 40 equiv.) is added and the solution is stirred at 40° C. under argon for 30 min. An excess of diisopropylethylamine (DIEA) is subsequently added in order to neutralize the catalyst, and the solvent is evaporated under vacuum. The polymer is then dissolved in the minimum amount of dichloromethane, precipitated by addition to cold methanol, filtered off and dried under vacuum.

The results obtained are as follows:

A PCL-b-PTMC-b-PCL copolymer is obtained with a degree of conversion of greater than 96% and a yield of 81%.

¹H NMR (CDCl₃, 300 MHz): 4.23 (t, 4H×55, J=6.3 Hz, n —OCH₂CH₂CH₂O—), 4.12 (t, 4H, J=6.7 Hz, —(CH₂)₅C(O)OCH₂CH₂CH₂), 4.05 (t, 2H×26, J=6.6 Hz, —OCH₂(CH₂)₄C(O)—), 3.64 (t, 4H, J=6.5 Hz, HOCH₂(CH₂)₄—), 2.30 (t, 2H×26, J=7.5 Hz, —COCH₂(CH₂)₄O—), 2.04 (m, 2H×55+4H, n —OCH₂CH₂CH₂O and —OCH₂CH₂CH₂OH), 1.64 (m, 4H×26+4H, —OCH₂CH₂CH₂CH₂CH₂C(O) and HOCH₂CH₂CH₂CH₂CH₂C(O)), 1.38 (m, 2H×26+2H+2H, —O(CH₂)₂CH₂(CH₂)₂C(O) and HO(CH₂)₂CH₂(CH₂)₂C(O)).

The absence of triplet signal 3.74 ppm (corresponding to the CH₂OH group of an end TMC unit) indicates that all the polymer chains have CH₂OH ends of the caprolactone unit (t signal at 3.64 ppm). This confirms the absence of telechelic PTMC homopolymer.
SEC (THF): Mn˜13 300 g/mol, PDI: Mw/Mn˜1.18;
DSC: T_{g1}: not observed; T_{g2}=−22.5° C., Tₘ=39.5° C.

The T_{g} value observed (−22.5° C.) is similar to the glass transition temperature of the PTMC homopolymer, indicating the observation of a phase segregation between the PTMC and PCL blocks. The size and the semicrystalline nature of the PCL block makes it difficult to observe the T_{g1} corresponding to this block.

1-7. (canceled)

8. A process for controlling the structure of a block copolymer by selective copolymerization, by ring opening, of cyclic carbonate and lactone monomers in the presence of a catalyst based on methanesulfonic acid, comprising in succession:
(a) dissolving a cyclic carbonate monomer in a nonchlorinated aromatic solvent to produce a monomer solution, followed by
(b) adding a bifunctional initiator chosen from diols or water to the monomer solution from (a), followed by
(c) adding methanesulfonic acid (MSA) to the solution from (b), followed by
(d) polymerizing the cyclic carbonate monomer in the solution from (c), wherein when all the cyclic carbonate has been consumed, a telechelic polycarbonate capable of acting as macroinitiator of polymerization of the lactone is obtained, and followed by
(e) adding the lactone to the reaction medium from (d) in order to selectively obtain a block copolymer.

9. The process of claim 8, wherein the cyclic carbonate is trimethylene carbonate (TMC), the lactone is s-caprolactone (s-CL), and the block copolymer is a P(CL-b-TMC-b-CL) triblock copolymer.

10. The process of claim 9, wherein the molar ratio of monomers to bifunctional initiator, TMC/s-CL/bifunctional initiator, is between 60/60/1 and 120/240/1.

11. The process of claim 8, wherein the bifunctional initiator/methanesulfonic acid (MSA) molar ratio is between 1/1 and 1/3.

12. The process of claim 8, which is conducted at a temperature of between 20 and 120° C.

13. The process of claim 8, which is conducted at a temperature of between 30° C. and 60° C.

14. The process of claim 8, wherein the nonchlorinated aromatic solvent is toluene, ethylbenzene or xylene.

15. The process of claim 8, wherein the cyclic carbonate is trimethylene carbonate (TMC).

16. The process of claim 8, wherein the lactone is s-caprolactone (s-CL).

17. The process of claim 8, wherein the nonchlorinated aromatic solvent is toluene.

18. The process of claim 8, wherein the block copolymer obtained is a P(CL-b-TMC-b-CL) triblock copolymer.

19. The process of claim 8, wherein the bifunctional initiator comprises water.

20. The process of claim 8, wherein the bifunctional initiator comprises a diol.

21. The process of claim 8, which is conducted continuously or batchwise.

22. The process of claim 8, wherein the block copolymer exhibits a linear morphology.

23. The process of claim 8, wherein the block copolymer is obtained free from contamination by other copolymers or homopolymers.

24. The process of claim 8, wherein the block copolymer is a triblock copolymer.

25. The process of claim 8, wherein the block copolymer contains nanodomains.

26. A PCL-b-PTMC-b-PCL block copolymer obtained by the process of claim 8, wherein
each of the PCL blocks exhibits a degree of polymerization of between 30 and 120 and a number-average molecular weight Mn of between 3400 and 13680 g/mol, and
the PTMC block exhibits a degree of polymerization of between 60 and 120 and a number-average molecular weight Mn of between 6100 and 12200 g/mol.
